(19) United States
(12) Patent Application Publication
(10) Pub. No.: US 2019/0246003 A1
(43) Pub. Date: Aug. 8, 2019

(54) MULTIFUNCTIONAL PAPER-INTERACTING DEVICE

(71) Applicant: G.P.P.S. LTD., Misgav (IL)

(72) Inventor: Belal LEHAWANY, Arrabi (IL)

(21) Appl. No.: 16/341,926

(22) PCT Filed: Mar. 14, 2017
(86) PCT No.: PCT/IL2017/050326

§ 371 Date: Apr. 15, 2019

Related U.S. Application Data
(60) Provisional application No. 62/408,781, filed on Oct. 16, 2016.
(60) Provisional application No. 62/408,782, filed on Oct. 16, 2016.

(51) Int. Cl. H04N 1/34; H04N 1/00; G06Q 20/18

(52) U.S. Cl. CPC H04N 1/344; H04N 2201/0094; G06Q 20/18; H04N 1/00384

(57) ABSTRACT

A paper-interacting device, connected to a computerized network via a network connection, the paper-interacting device comprising an input means and a processor, the processor configured to: obtain payment-related information from a user operating the input means; send an authentication request, comprising the payment-related information, to a remote payment authentication server, wherein the authentication request is sent via the network connection; receive, via the network connection, an authentication response originating from the remote payment authentication server; and enable the paper-interactive device to perform a paper-interactive operation upon the authentication response being indicative of a successful authentication of the authentication request.

### TECHNICAL FIELD

The invention relates to a multifunctional paper-interacting device and methods of operation thereof.

### BACKGROUND

Paper-interacting devices, such as printers, photocopiers, scanners, fax machines, or any other device that receives input from a paper, or provides output to a paper, are frequently used in various places. In many public places, such as universities, public libraries, hospitals, business or governmental organizations, etc., pay-per-use paper-interacting devices are positioned. Various methods exist for paying for printing/scanning/photocopying/faxing or any other paper-interactive operation performed by the paper-interacting device. Such methods include payment by depositing coin or payment using payment cards such as debit or credit cards. In those cases, where payment is made using payment cards, there is a need to authenticate the payment cards and to handle the payment itself. Authentication of the payment cards requires access to remote authentication servers. Nowadays, the entire handling of the payment using payment cards, including the authentication thereof, is performed by dedicated card readers having processing means and a network connection that are separate than the paper-interacting device's processing means and network connection, thereby resulting in unwanted redundancy.

In addition, in some cases it is desirable to provide users of such paper-interacting devices with free services. In such cases, integration of promotional and/or marketing material to outputs of the paper-interacting devices (e.g. integration of the promotional and/or marketing material onto printed media/photocopy documents/digitally scanned materials/faxed materials) may be desirable. Utilization of free spaces within outputs of the paper-interacting devices (e.g. scanned pages, printed pages, faxed pages, photocopied pages), for providing marketing/promotional materials, can result in reducing consumption of papers dedicated to be used for marketing and/or promotional purposes only.

There is thus a need in the art for a new multifunctional paper-interacting device.

U.S. Pat. No. 6,712,266 (Bartley et al.), published on Mar. 30, 2004 discloses a networked copier and printer system that permits on-line payment for use of copier or computer printer, charging against a positive balance customer account stored at a central station, and permits customers to add to their copier account. A network transaction station accepts a customer ID from a magnetic card or bar code reader, or from a keypad input. After the customer enters his or her PIN, the account balance is downloaded from the central database, and the copier or printer is enabled. An add-value station on the network allows the customer to deposit cash and add to his or her account balance, after entering a customer ID and PIN. The value-added station presents a receipt that omits the customer account identification but contains a unique transaction tracking code. An off-line mode permits copying during network outages.

U.S. Pat. No. 7,492,472 B2 (Penke et al.), published on Feb. 17, 2009 discloses a hub allowing collaboration and communication, including delayed and secure printing, faxing, telephone service, internet and e-mail access, and data transfer between personal electronic devices and the hub and/or other personal electronic devices and/or remote devices. Embodiments operate on a fee-for-service basis and can include a payment acceptance module. Embodiments include a large main display on which advertisements and information can be displayed during periods of non-use. Additional displays can be included with associated input devices to allow multiple users to use the hub simultaneously. Embodiments can include networking ports, wired and/or wireless, with which users can connect devices to the hub for data transfer, sharing, and collaboration.

### GENERAL DESCRIPTION

In accordance with a first aspect of the presently disclosed subject matter, there is provided a paper-interacting device, connected to a computerized network via a network connection, the paper-interacting device comprising an input means and a processor, the processor configured to: obtain payment-related information originating from a user operating the input means; send an authentication request, comprising the payment-related information, to a remote payment authentication server, wherein the authentication request is sent via the network connection; receive, via the network connection, an authentication response originating from the remote payment authentication server; and enable the paper-interactive device to perform a paper-interactive operation upon the authentication response being indicative of a successful authentication of the authentication request.

In some cases, the paper-interactive device is capable of performing one or more of the following operations: printing, scanning, faxing, photocopying.

In some cases, the paper-interactive operation is one or more of the following operations: printing, scanning, faxing, photocopying.

In some cases, the input means includes one or more of the following: a touch screen, a keypad, a keyboard, a card reader.

In some cases, the payment-related information includes at least an identification number identifying a payment means of the user.

In some cases, the payment means is a credit or debit card.

In some cases, the authentication response includes an indication of a balance in the user's account, and wherein the paper-interactive device is enabled to perform the paper-interactive operation if the balance is sufficient in accordance with a cost of the paper-interactive operation.

In accordance with a second aspect of the presently disclosed subject matter, there is provided a method of operating a paper-interacting device connected to a computerized network via a network connection, the paper-interacting device comprising an input means, the method comprising: obtaining, by a processor, payment-related information originating from a user operating the input means; sending, by the processor, an authentication request, comprising the payment-related information, to a remote payment authentication server, wherein the authentication request is sent via the network connection; receiving, by the processor, via the network connection, an authentication response originating from the remote payment authentication server; and enabling, by the processor, the paper-interactive device to perform a paper-interactive operation upon the authentication response being indicative of a successful authentication of the authentication request.

In some cases, the paper-interactive device is capable of performing one or more of the following operations: printing, scanning, faxing, photocopying.

In some cases, the paper-interactive operation is one or more of the following operations: printing, scanning, faxing, photocopying.

In some cases, the input means includes one or more of the following: a touch screen, a keypad, a keyboard, a magnetic stripe card reader.

In some cases, the payment-related information includes at least an identification number identifying a payment means of the user.

In some cases, the payment means is a credit or debit card.

In some cases, the authentication response includes an indication of a balance in the user's account, and wherein the paper-interactive device is enabled to perform the paper-interactive operation if the balance is sufficient in accordance with a cost of the paper-interactive operation.

In accordance with a third aspect of the presently disclosed subject matter, there is provided a non-transitory computer readable storage medium having computer readable program code embodied therewith, the computer readable program code, executable by at least one processor of a paper-interacting device to perform a method, wherein the paper-interacting device is connected to a computerized network via a network connection, the paper-interacting device comprising an input means, and wherein the method comprising: obtaining, by the processor, payment-related information originating from a user operating the input means; sending, by the processor, an authentication request, comprising the payment-related information, to a remote payment authentication server, wherein the authentication request is sent via the network connection; receiving, by the processor, via the network connection, an authentication response originating from the remote payment authentication server; and enabling, by the processor, the paper-interactive device to perform a paper-interactive operation upon the authentication response being indicative of a successful authentication of the authentication request.

In accordance with a fourth aspect of the presently disclosed subject matter, there is provided a paper-interacting device comprising an input means and a processor, the processor configured to: obtain a digital representation of a page comprising first content; dynamically superimpose second content over the digital representation of the page, giving rise to an updated page comprising the first content and the second content; and output the updated page to a user.

In some cases, the paper-interacting device includes a scanner, the digital representation of the page is a digital file comprising a scan of a real-world page obtained by the scanner and the output is sent to an email address of the user.

In some cases, the paper-interacting device includes a facsimile, the digital representation of the page is a digital file comprising a scan of a real-world page obtained by the facsimile and the output is sent to a second facsimile according to a facsimile number provided by the user.

In some cases, the paper-interacting device includes a photocopier, the digital representation of the page is a digital file comprising a scan of a real-world page obtained by the photocopier and the output is printed by the paper-interacting device.

In some cases, the paper-interacting device includes a printer, the digital representation of the page is a digital file generated by a computer and the output is printed by the printer.

In some cases, the second content includes one or more marketing and/or promotional materials.

In some cases, the processor is further configured to identify free spaces within the digital representation of the page, and wherein the second content is dynamically superimposed onto the identified free spaces.

In some cases, the processor is further configured to match each of the one or more marketing and/or promotional materials to a corresponding free space of the free spaces having dimensions closest to the corresponding marketing and/or promotional material.

In some cases, the processor is further configured to repeat the obtain, the dynamically superimpose and the output, without charging the user, as long as the paper-interacting device has access to one or more additional marketing and/or promotional materials, not presented on any previously outputted updated pages outputted for the user.

In some cases, the one or more additional marketing and/or promotional materials include at least one criteria matched with information associated with the user.

In some cases, the second content is retrieved from a remote server.

In some cases, the remote server is a third-party server.

In accordance with a fifth aspect of the presently disclosed subject matter, there is provided a method of operating a paper-interacting device connected to a computerized network via a network connection, the paper-interacting device comprising an input means, the method comprising: obtaining, by a processor, a digital representation of a page comprising first content; dynamically superimposing, by the processor, second content over the digital representation of the page, giving rise to an updated page comprising the first content and the second content; and outputting, by the processor, the updated page to a user.

In some cases, the paper-interacting device includes a scanner, the digital representation of the page is a digital file comprising a scan of a real-world page obtained by the scanner and the output is sent to an email address of the user.

In some cases, the paper-interacting device includes a facsimile, the digital representation of the page is a digital file comprising a scan of a real-world page obtained by the facsimile and the output is sent to a second facsimile according to a facsimile number provided by the user.

In some cases, the paper-interacting device includes a photocopier, the digital representation of the page is a digital file comprising a scan of a real-world page obtained by the photocopier and the output is printed by the paper-interacting device.

In some cases, the paper-interacting device includes a printer, the digital representation of the page is a digital file generated by a computer and the output is printed by the printer.

In some cases, the second content includes one or more marketing and/or promotional materials.

In some cases, the method further comprises identifying free spaces within the digital representation of the page, wherein the second content is dynamically superimposed onto the identified free spaces.

In some cases, the method further comprises matching each of the one or more marketing and/or promotional materials to a corresponding free space of the free spaces having dimensions closest to the corresponding marketing and/or promotional material.

In some cases, the method further comprises repeating the obtain, the dynamically superimpose and the output, without charging the user, as long as the paper-interacting device has access to one or more additional marketing and/or promotional materials, not presented on any previously outputted updated pages outputted for the user.

In some cases, the one or more additional marketing and/or promotional materials include at least one criteria matched with information associated with the user.

In some cases, the second content is retrieved from a remote server.

In some cases, the remote server is a third-party server.

In accordance with a sixth aspect of the presently disclosed subject matter, there is provided a non-transitory computer readable storage medium having computer readable program code embodied therewith, the computer readable program code, executable by at least one processor of a paper-interacting device to perform a method, wherein the paper-interacting device is connected to a computerized network via a network connection, the paper-interacting device comprising an input means, and wherein the method comprising: obtaining, by a processor, a digital representation of a page comprising first content; dynamically superimposing, by the processor, second content over the digital representation of the page, giving rise to an updated page comprising the first content and the second content; and outputting, by the processor, the updated page to a user.

### BRIEF DESCRIPTION OF DRAWINGS

In order to understand the presently disclosed subject matter and to see how it may be carried out in practice, the subject matter will now be described, by way of non-limiting examples only, with reference to the accompanying drawings, in which:

FIG. 1 is a block diagram schematically illustrating one example of a system for operating a paper-interacting device, in accordance with the prior art;

FIG. 2 is a block diagram schematically illustrating one example of a system for operating a paper-interacting device, in accordance with the presently disclosed subject matter;

FIG. 3 is a flowchart illustrating one example of a sequence of operations carried out for performing a paper-interacting operation, in accordance with the presently disclosed subject matter;

FIG. 4 is a block diagram schematically illustrating another example of a system for operating a paper-interacting device, in accordance with the presently disclosed subject matter;

FIG. 5 is a flowchart illustrating another example of a sequence of operations carried out for performing a paper-interacting operation, in accordance with the presently disclosed subject matter; and

FIG. 6 is schematic illustration of a page comprising blank spaces.

### DETAILED DESCRIPTION OF THE INVENTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “enabling”, “obtaining”, “sending”, “receiving”, or the like, include action and/or processes of a computer that manipulate and/or transform data into other data, said data represented as physical quantities, e.g. such as electronic quantities, and/or said data representing the physical objects. The terms “computer”, “processor”, and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

The operations in accordance with the teachings herein may be performed by a computer specially constructed for the desired purposes or by a general-purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

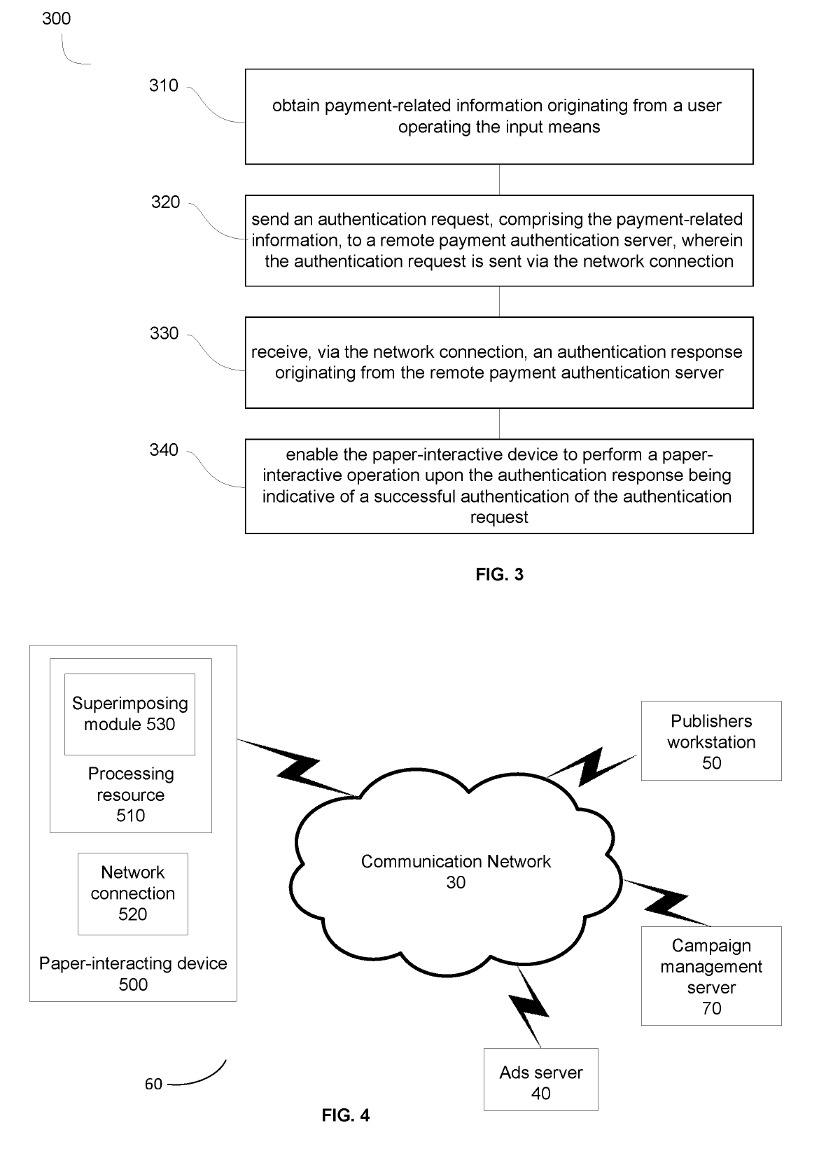

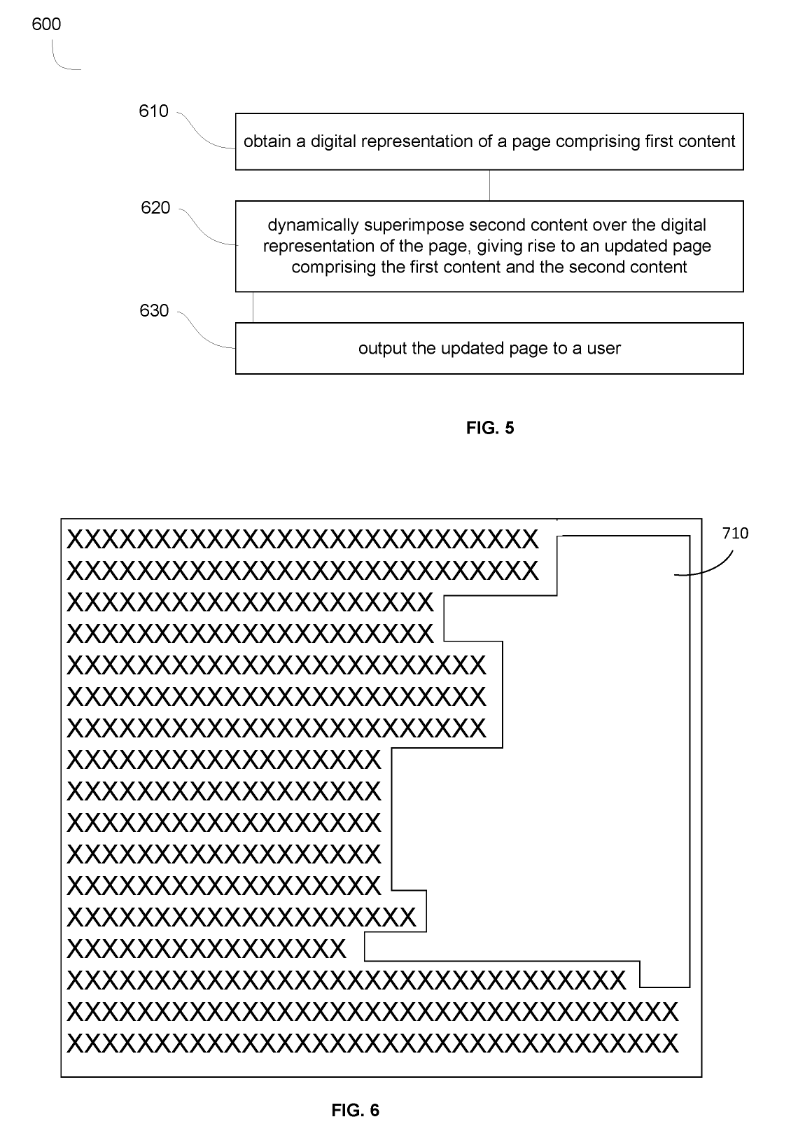

In embodiments of the presently disclosed subject matter, fewer, more and/or different stages than those shown in FIGS. 3 and 5 may be executed. In embodiments of the presently disclosed subject matter one or more stages illustrated in FIGS. 3 and 5 may be executed in a different order and/or one or more groups of stages may be executed simultaneously. FIGS. 2 and 4 illustrate a general schematic of the system architecture in accordance with an embodiment of the presently disclosed subject matter. Each module in FIGS. 2 and 4 can be made up of any combination of software, hardware and/or firmware that performs the functions as defined and explained herein. The modules in FIGS. 2 and 4 may be centralized in one location or dispersed over more than one location. In other embodiments of the presently disclosed subject matter, the system may comprise fewer, more, and/or different modules than those shown in FIGS. 2 and 4.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

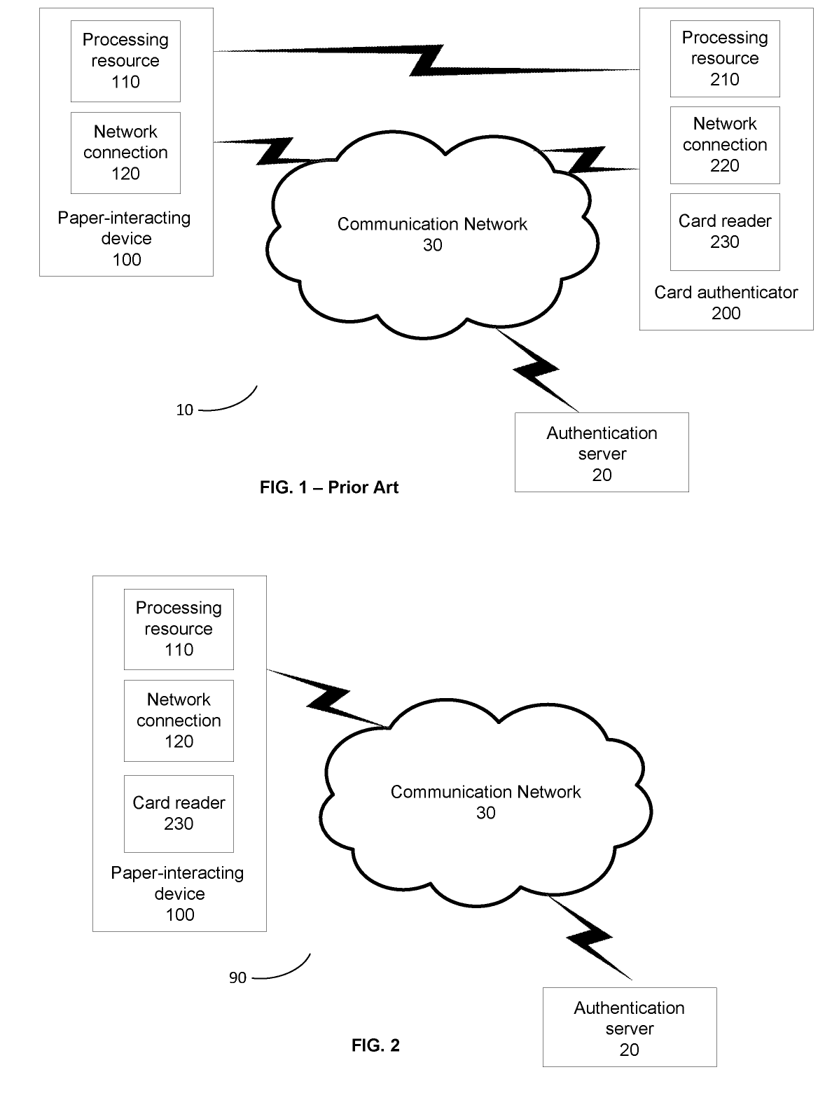

Bearing this in mind, attention is drawn to FIG. 1, showing a block diagram schematically illustrating one example of a system for operating a paper-interacting device, in accordance with the prior art.

The system 10 of the prior art includes a paper-interacting device 100, a card authenticator 200 and an authentication server 20. The paper-interacting device 100 can be a printer, a photocopier, a scanner, a fax machine, or any other device that receives input from a paper (e.g. by scanning it), and/or provides output to a paper (e.g. by printing it, or sending it to a device other than the paper-interacting device 100), or any combination of two or more of the above. The card authenticator 200 of the system 10 according to the prior art is a separate device (separate from the paper-interacting device 100) capable of obtaining payment-related information from a user (e.g. utilizing a card reader 230 (e.g. a magnetic stripe card reader, a contactless smart card reader, a contact smart card reader, etc.), or any other mechanism enabling a user to provide the card authenticator with payment-related information), and authenticating the payment-related information to determine if payment can be accepted from the user. The payment-related information can be authenticated by communicating with an authentication server 20, (executing an appropriate service), that can be physical/virtual server, or group of servers, optionally in a cloud environment. The authentication server 20 can optionally be a third-party physical/virtual server.

The paper-interacting device 100 can include a processing resource 110 and a network connection 120. The processing resource 110 can include one or more processing units (e.g. central processing units), microprocessors, microcontrollers (e.g. microcontroller units (MCUs)) or any other computing devices or modules, including multiple and/or parallel and/or distributed processing units, which are adapted to independently or cooperatively process data for controlling relevant paper-interacting device 100 resources and for enabling operations related to paper-interacting device 100 resources (e.g. printing, photocopying, faxing, scanning, etc.).

The network connection 110 can be any hardware (including, for example a wired/wireless network card, WiFi, Bluetooth, etc.) enabling connecting the paper-interacting device 100 to communication network 30 and enabling it to send data and/or receive data sent thereto, through the communication network 30, including enabling it to communicate with a card authenticator 200 for receiving instructions to allow a user to use the paper-interacting device 100, and/or for obtaining required information for performing a paper-interacting operation (e.g. obtaining a document for printing), as further detailed herein. A paper-interacting operation is any operation that required interaction with a paper, whether as input, or as output (e.g. printing, faxing, scanning, photocopying, etc.).

The card authenticator 200 can include a processing resource 210, a network connection 220, and optionally a card reader 230 (e.g. a magnetic stripe card reader, a contactless smart card reader, a contact smart card reader, etc.) or any other input means (e.g. keyboard/keypad/touch screen) enabling a user to provide payment-related information such as a credit/debit card number and/or user name and password.

The processing resource 210 can include one or more processing units (e.g. central processing units), microprocessors, microcontrollers (e.g. microcontroller units (MCUs)) or any other computing devices or modules, including multiple and/or parallel and/or distributed processing units, which are adapted to independently or cooperatively process data for controlling relevant card authenticator 200 resources and for enabling operations related to card authenticator 200 resources.

The network connection 210 can be any hardware (including, for example a wired/wireless network card, WiFi, Bluetooth, etc.) enabling connecting the card authenticator 200 to communication network 30 and enabling it to send data and/or receive data sent thereto, through the communication network 30, including enabling it to communicate with an authentication server 20 for authenticating payment-related information obtained from a user, as further detailed herein.

In the system 10 according to the prior art, a user that wishes to utilize the paper-interacting device 100 is required to operate the card authenticator's 200 card reader 230 (e.g. a magnetic stripe card reader, a contactless smart card reader, a contact smart card reader, etc.), or any other input means (e.g. keyboard/keypad/touch screen) enabling a user to provide payment-related information such as a credit/debit card number and/or user name and password, for providing payment-related information. The payment-related information can be, for example, a credit or debit card number, or any other/additional information required for identifying the user and/or the user's payment means.

The card authenticator 200 utilizes the network connection 220 to send the payment-related information to the authentication server 20 over the communication network 30. The authentication server 20 either approves the payment means, or rejects it. In some cases, e.g. when paying with a debit card or a pre-paid card, the authentication server 20 can also notify the card authenticator of a remaining balance in the user's account (that may have limited available funds).

If the payment-related information is authenticated, the card authenticator 200 can notify the paper-interacting device 100 that it can enable the user to utilize it for performing one or more paper-interacting operations. If the user's balance is limited (e.g. in the case of a debit card or a pre-paid card, etc.), it can also provide the paper-interacting device 100 with information of the remining balance so that the paper-interacting device 100 will be able to limit its use accordingly (e.g. if the balance suffices for printing only five pages—only five pages will be printed). Alternatively, the paper-interacting device 100 can request authorization from the card authenticator 200 before performing each chargeable paper-interacting operation (e.g. before printing each page), so that before performing each chargeable paper-interacting operation the card authenticator 200 is required to authorize performance of the paper-interacting operation (which can optionally require checking a remaining balance in the user's account).

After performing the paper-interacting operation, the paper-interacting device 100 or the card authenticator 200 can receive information enabling it to determine the price of the paper-interactive operation/s for purpose of charging the user.

It is to be noted that any communication between the paper-interacting device 100 and the card authenticator 200 can be performed using their respective network connections (120 and 220), or using a dedicated wired/wireless connection (including Bluetooth, NFC, or any other type of connection enabling transfer of data between the paper-interacting device 100 and the card authenticator 200).

It is to be further noted, and emphasized, that according to the system 10 of the prior art, the paper-interacting device 100 and the card authenticator 200 both have a processing resource and a network connection, which they do not share.

Having described the system 10 in accordance with the prior art, attention is drawn to FIG. 2, showing a block diagram schematically illustrating one example of a system for operating a paper-interacting device, in accordance with the presently disclosed subject matter.

The system 90 in accordance with the presently disclosed subject matter includes a paper-interacting device 100, and an authentication server 20. The paper-interacting device 100 can be a printer, a photocopier, a scanner, a fax machine, or any other device that receives input from a paper (e.g. by scanning it), and/or provides output to a paper (e.g. by printing it, or sending it to a device other than the paper-interacting device 100), or any combination of two or more of the above. The functionality of the card authenticator 200 of system 10 according to the prior art is now incorporated into the paper-interacting device 100. The paper-interacting device 100 in accordance with the presently disclosed subject matter is capable of obtaining, by itself, payment-related information from a user (e.g. utilizing a card reader 230 (e.g. a magnetic stripe card reader, a contactless smart card reader, a contact smart card reader, etc.), or any other mechanism enabling a user to provide the card authenticator with payment-related information), and authenticating the payment-related information to determine if payment can be accepted from the user. The payment-related information can be authenticated by the paper-interacting device 100 communicating with the authentication server 20 (executing an appropriate service), that can be physical/virtual server, or group of servers, optionally in a cloud environment. The authentication server 20 can optionally be a third-party physical/virtual server.

The paper-interacting device 100 includes a processing resource 110, a network connection 120 and a card reader 230 (e.g. a magnetic stripe card reader, a contactless smart card reader, a contact smart card reader, etc.), or any other input means (e.g. keyboard/keypad/touch screen) enabling a user to provide payment-related information such as a credit/debit card number and/or user name and password or any other identification number/string identifying the payment means of the user), all optionally comprised within the paper-interacting device 100. The processing resource 110 can include one or more processing units (e.g. central processing units), microprocessors, microcontrollers (e.g. microcontroller units (MCUs)) or any other computing devices or modules, including multiple and/or parallel and/or distributed processing units, which are adapted to independently or cooperatively process data for controlling relevant paper-interacting device 100 resources and for enabling paper-interacting operations related to paper-interacting device 100 resources (e.g. printing, photocopying, faxing, scanning, etc.).

The network connection 110 can be any hardware (including, for example a wired/wireless network card, WiFi, Bluetooth, etc.) enabling connecting the paper-interacting device 100 to communication network 30 and enabling it to send data and/or receive data sent thereto, through the communication network 30, including enabling it to communicate with an authentication server 20 for authenticating payment-related information obtained from a user, and/or for obtaining required information for performing the paper-interacting operation (e.g. obtaining a document for printing), as further detailed herein.

In accordance with the presently disclosed subject matter, a user that wishes to utilize the paper-interacting device 100 is required to operate the paper-interacting device's 100 card reader 230 (e.g. a magnetic stripe card reader, a contactless smart card reader, a contact smart card reader, etc.) or any other input means (e.g. keyboard/keypad/touch screen) enabling a user to provide payment-related information such as a credit/debit card number and/or user name and password or any identification number/string identifying the payment means of the user) for providing payment-related information. The payment-related information can be, for example, a credit or debit card number, or any other/additional information required for identifying the user and/or the user's payment means.

The paper-interacting device's 100 utilizes the network connection 120 to send the payment-related information to the authentication server 20 over the communication network 30. The authentication server 20 either approves the payment means, or rejects it. In some cases, e.g. when paying with a debit card or a pre-paid card, the authentication server 20 can also notify the card authenticator of a remaining balance in the user's account (that may have limited available funds). It is to be noted that in some cases the authentication server 20 can communicate with another third-party server (e.g. a credit card issuer server, not shown) to authenticate the payment means.

If the payment-related information is authenticated, the paper-interacting device 100 can enable the user to utilize it for performing one or more paper-interacting operations. If the user's balance is limited (e.g. in the case of a debit card or a pre-paid card, etc.), it can also limit its use accordingly (e.g. if the balance suffices for printing only five pages—only five pages will be printed).

After performing the paper-interacting operation, the paper-interacting device 100 can charge the user according to the paper-interactive operations made (e.g. charge the user's credit/debit card).

It is to be noted, and emphasized, that in the system 90 of the presently disclosed subject matter, the paper-interacting device 100 utilizes its processing resource 110 and its network connection 120 for performing the functionality of the card authenticator, which is now redundant. This enables saving unnecessary hardware, including processing resources and network resources and infrastructure (as a single network connection can be utilized instead of at least two separate network connections).

Turning to FIG. 3, there is shown a flowchart illustrating one example of a sequence of operations carried out for performing a paper-interacting operation, in accordance with the presently disclosed subject matter.

According to some examples of the presently disclosed subject matter, paper-interacting device 100 can be configure to perform a paper-interacting operation performance process 300, e.g. utilizing paper-interacting module comprised within the processing resource 110 (not shown).

For this purpose, paper-interacting device 100 is configured to obtain payment-related information originating from a user operating input means of the paper-interacting device 100, such as card reader 230 (e.g. magnetic stripe card reader/contactless smart card reader/contact smart card reader), (or any other input means (e.g. keyboard/keypad/touch screen) enabling a user to provide payment-related information such as a credit/debit card number and/or user name and password (block 310). In some cases, the payment-related information includes at least an identification number/string, identifying the payment means (e.g. a credit/debit card number).

The paper-interacting device 100 is further configured to send an authentication request, comprising the payment-related information, to a remote payment authentication server 20 (block 320). The authentication request is sent via a network connection 120 of the paper-interacting device 100.

After authentication of the authentication request by the remote payment authentication server 20, the paper-interacting device 100 receives, via its network connection, an authentication response originating from the remote payment authentication server 20 (block 330).

If the authentication response is indicative of a successful authentication of the authentication request, the paper-interacting device 100 can enable the user to perform a paper-interactive operation (block 340). In some cases, the authentication response can include an indication of a remaining balance in the user's account. In such cases, the paper-interacting device 100 can restrict the paper-interactive operation in accordance with such remaining balance and in accordance with a cost of the paper-interactive operation.

It is to be noted that, with reference to FIG. 3, some of the blocks can be integrated into a consolidated block or can be broken down to a few blocks and/or other blocks may be added. It should be noted that whilst the flow diagram is described also with reference to the system elements that realizes them, this is by no means binding, and the blocks can be performed by elements other than those described herein.

Having described the paper-interacting device 100 having payment authentication capabilities, attention is now drawn to FIG. 4. FIG. 4 is a block diagram schematically illustrating another example of a system for operating a paper-interacting device, in accordance with the presently disclosed subject matter. The system 60 shown in FIG. 4 is configured to enable a user of a paper-interacting device 500 to perform paper-interacting operations free of charge, in exchange of superimposing content on an output of such paper-interacting operations, as further detailed herein, with respect to FIG. 5. If the user is not interested in free paper-interacting operations in exchange of superimposing content on the output thereof, the paper-interacting device 500 can enable the user to select a pay-per-operation mode, in which the user is required to pay for each paper-interacting operation (e.g. pay for printing each page, faxing each page, scanning each page, photocopying each page, etc.), and no content will be superimposed on the output of such paper-interacting operations.

In some cases, the content superimposed on the output of the paper-interacting operations is one or more promotional or marketing material. The promotion or marketing material can be an advertisement, a coupon, or any other promotional or marketing material. In some cases, the content can be stored on an ads server 40 (that can optionally be a third-party server), e.g. on a data repository (e.g. a database, a storage system, a memory including Read Only Memory—ROM, Random Access Memory—RAM, or any other type of memory, etc.) thereof. The paper-interacting device 500 can retrieve one or more promotional or marketing material from the ads server 40, e.g. utilizing a network connection 520 (e.g. a wired or wireless network connection, enabling communication with the ads server 40, and with a campaign management server 70) thereof, and superimpose the retrieved material on the output of the paper-interacting operation. In such case, when the user selects the option of free printing, the entity that will pay for the paper-interacting operation is a publisher that provides the superimposed marketing and/or promotional material. In order to track the promotional/marketing material utilization, the paper-interacting device 500 can notify a campaign management server 70 of each utilization of the promotion/marketing material (e.g. of each instance of such promotion/marketing material superimposed on output of a paper-interacting operation performed by the paper-interacting device 500).

The promotional or marketing material can be introduced to the ads servers' 40 data-repository by the publisher, by operating a publisher workstation 50. The publisher workstation 50 can enable the publisher to introduce promotional and/or marketing material to the ads server 40, e.g. utilizing a dedicated user interface (optionally a web-interface, optionally requiring the publisher to provide identification information (e.g. user name and password) for logging into a dedicated website). In some cases, the user interface can enable the publisher to provide various additional parameters to the promotional and/or marketing materials. The parameters can include one or more of the following: (a) an advertising budget, defining a maximal budget for a promotional and/or marketing campaign (i.e. a maximal payment that the publisher is willing to pay for superimposing the promotional and/or marketing materials provided thereby on output of paper-interacting operations); (b) an advertisement schedule, defining one or more time-windows during which the campaign is active (e.g. the publisher can offer to pay for paper-interacting operations having superimposed promotional and/or marketing materials provided thereby for a period of one day/week/month, optionally in certain times of day, optionally in certain days of the week, etc.); (c) a target audience (e.g. the publisher can segment the audience to which the promotional and/or marketing materials are aimed, by gender/age/professions/titles/home address/work address/education/etc.); (d) a geographic area (e.g. the publisher can select a geographic area comprising one or more paper-interacting devices 500 for the promotional/marketing campaign, or select certain specific paper-interacting devices, e.g. using an identification thereof); (e) a certain location for placing the promotional/marketing materials (e.g. the publisher can select to place the promotional/marketing material only on the back/top/bottom/left margins/right margins/etc. of output pages); (f) a minimal/maximal size of the promotional/marketing material on the output pages (e.g. the publisher can define that the promotional/marketing material will be provided in a certain size, e.g. larger than a minimal threshold and/or smaller than a maximal threshold, and such promotional/marketing materials will not be provided if there is no sufficient space on the output page, etc.); (g) a maximal number of sponsored paper-interacting operations per-user (in some cases, a certain publisher can decide that it only offers to pay for up to a certain number of paper-interacting operations for each user). It is to be noted that these are merely examples of parameters, and other/additional parameters may be provided.

As indicated above, the paper-interacting device 500 can notify a campaign management server 70 (that can optionally be the same server as ads server 40) of each utilization of the promotion/marketing material. In such cases, the paper-interacting device 500 can also provide the campaign management server 70 with various information relating to the user to which each instance of the promotion/marketing material was provided. Providing such additional information can enable the campaign management server 70 to provide the publisher with various reports and statistics about the promotion/marketing campaign, including budget utilization, segmentation of the audience that received the promotion/marketing materials, how many instances of each of the promotion/marketing materials were provided, etc. In some cases, the reports can be provided to the publisher via the user interface provided on the publisher workstation 50. The user interface can be a web-interface, and the publisher may be required to provide identification information (e.g. user name and password) for logging into the website showing the reports.

The paper-interacting device 500 can include a processing resource 510. The processing resource 510 can include one or more processing units (e.g. central processing units), microprocessors, microcontrollers (e.g. microcontroller units (MCUs)) or any other computing devices or modules, including multiple and/or parallel and/or distributed processing units, which are adapted to independently or cooperatively process data for controlling relevant paper-interacting device 500 resources and for enabling operations related to paper-interacting device 500 resources (e.g. printing, photocopying, faxing, scanning, etc.).

The processing resource 510 can include a superimposing module 530, configured to superimpose content on an output of paper-interacting operations performed by the paper-interacting device 500, as further detailed herein, with respect to FIG. 5

Turning to FIG. 5, there is shown a flowchart illustrating another example of a sequence of operations carried out for performing a paper-interacting operation, in accordance with the presently disclosed subject matter.

According to some examples of the presently disclosed subject matter, paper-interacting device 500 can be configure to perform a superimposing process 600, e.g. utilizing superimposing module 530 comprised within the processing resource 510 of the paper-interacting device 500.

For this purpose, superimposing module 530 is configured to obtain a digital representation of a page comprising first content (block 610). The digital representation of the page can be a raw scanned document scanned by the paper-interacting device 500 for any purpose (e.g. for sending to an email account, for faxing to a certain destination, for photocopying, etc.). In other cases, the digital representation of the page can be a page comprising text and/or images and/or any other content to be printed (e.g. a word processor page, a gif/jpg/any other picture format file, a power point page, a spreadsheet page, or any other page comprising content). It is to be noted that the digital representation of the page comprising first content is provided by the user of the paper-interacting device 500, operating the paper-interacting device 500 utilizing a user interface thereof.

In case the user selects to perform paper-interacting operations free of charge, superimposing module 530 is further configured to dynamically superimpose second content over the digital representation of the page, giving rise to an updated page comprising the first content and the second content (block 620). For this purpose, the superimposing module 530 can approach the ads server 40 to retrieve at least one promotion/marketing material provided by a publisher. It is to be noted that in the following description, reference is made to promotional/marketing materials as the second content. It is to be noted that this is not limiting and other types of content can be superimposed.

As indicated above, in some cases the publishers can determine various parameters associated with the promotional and/or marketing materials provided thereby. In such cases, the ads server 40 can provide a promotional/marketing material having parameter values that indicate that such promotional/marketing material can be provided by the specific paper-interacting device 500, and/or to the specific user in accordance with various information accessible by the paper-interacting device 500 and relating to the specific user, etc. As an example, it has been noted that the publisher can limit a marketing/promotional campaign to specific geographical locations and/or to specific paper-interacting devices 500. In such cases, the ads server 40 can provide a promotional/marketing material that meets such limitations, if any.

In some cases, there may be a limitation on the number of times each promotional/marketing material can be provided to the same user, so that the user will not receive the same marketing/promotional material more than such pre-determined number of times (e.g. one time). In such cases, the ads server 40 and/or the campaign management server 70, can monitor the number of times each promotional/marketing material was provided to each user, as further detailed herein.

The superimposing module 530 can superimpose the promotional/marketing material on any free space within the front of the outputted page, or, if applicable, within the back of the page. For example, if the outputted page is a printed page, and the printing is single sided, the promotional/marketing material can be superimposed on the back of the page, which is all available for placement of such promotional/marketing material. As another example, if the page comprises blank spaces surrounded by content, as shown in FIG. 6, the promotional/marketing material can be superimposed on such blank spaces 710 surrounded by other content. In some cases, various optimization algorithms can be employed for optimizing placement of the superimposed marketing/promotional material over the blank spaces, for example for superimposing as many marketing/promotional materials as possible over the blank spaces.

It is to be noted that if there is no suitable marketing/promotional material, the option of performing free paper-interacting operations can be disabled by the paper-interacting device 500, and the user can be required to provide payment for any paper-interacting operation. In some cases, the paper-interacting device 500 can pre-determine a maximal number of free paper-interacting operations, based on the availability of promotional and/or marketing material (optionally for the specific paper-interacting device 500 and/or for the specific user). For example, in case three marketing materials that can be provided to the specific user in the specific paper-interacting device 500 exist, the paper-interacting device 500 can notify the specific user that it can utilize up to three free paper-interacting operations, after which he will be required to pay for each paper-interacting operation.

After dynamically superimpose the second content over the digital representation of the page, which gives rise to an updated page comprising the first content and the second content, the updated page can be outputted to the user in accordance with the paper-interacting operation (block 630). If the paper-interacting operation is a scan operation, the updated document, comprising the first and the second content, can be sent to the user's email account for example. If the paper-interacting operation is a print or a photocopy operation, the updated document, comprising the first and the second content, can be printed. If the paper-interacting operation is a fax operation, the updated document, comprising the first and the second content, can be faxed to a destination fax according to a number provided by the user.

In some cases, the paper-interacting device 500 can notify the ads server 40 and/or the campaign management server 70, about the promotional/marketing material superimposed on the outputted page, so that the ads server 40 and/or the campaign management server 70 can monitor the number of times each promotional/marketing material was provided to each user, as further detailed herein.

In some cases, the paper-interacting device 500 can enable a user to repeat the superimposing process 600 as long as the paper-interacting device 500 has access to one or more additional marketing and/or promotional materials, not presented (or not presented over a pre-determined number of times set by a publisher) on any previously outputted updated pages outputted for the user.

It is to be noted that, with reference to FIG. 5, some of the blocks can be integrated into a consolidated block or can be broken down to a few blocks and/or other blocks may be added. It should be noted that whilst the flow diagram is described also with reference to the system elements that realizes them, this is by no means binding, and the blocks can be performed by elements other than those described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A paper-interacting device, connected to a computerized network via a network connection, the paper-interacting device comprising an input means and a processor, the processor configured to:
obtain payment-related information originating from a user operating the input means;
send an authentication request, comprising the payment-related information, to a remote payment authentication server, wherein the authentication request is sent via the network connection;
receive, via the network connection, an authentication response originating from the remote payment authentication server; and
enable the paper-interactive device to perform a paper-interactive operation upon the authentication response being indicative of a successful authentication of the authentication request.

2. The paper-interacting device of claim 1, wherein the paper-interactive device is capable of performing one or more of the following operations: printing, scanning, faxing, photocopying.

3. The paper-interacting device of claim 1, wherein the paper-interactive operation is one or more of the following operations: printing, scanning, faxing, photocopying.

4. The paper-interacting device of claim 1, wherein the input means includes one or more of the following: a touch screen, a keypad, a keyboard, a card reader.

5. The paper-interacting device of claim 1, wherein the payment-related information includes at least an identification number identifying a payment means of the user.

6. The paper-interacting device of claim 5 wherein the payment means is a credit or debit card.

7. The paper-interacting device of claim 1, wherein the authentication response includes an indication of a balance in the user's account, and wherein the paper-interactive device is enabled to perform the paper-interactive operation if the balance is sufficient in accordance with a cost of the paper-interactive operation.

8. A method of operating a paper-interacting device connected to a computerized network via a network connection, the paper-interacting device comprising an input means, the method comprising:
obtaining, by a processor, payment-related information originating from a user operating the input means;
sending, by the processor, an authentication request, comprising the payment-related information, to a remote payment authentication server, wherein the authentication request is sent via the network connection;
receiving, by the processor, via the network connection, an authentication response originating from the remote payment authentication server; and
enabling, by the processor, the paper-interactive device to perform a paper-interactive operation upon the authentication response being indicative of a successful authentication of the authentication request.

9. The method of claim 8, wherein the paper-interactive device is capable of performing one or more of the following operations: printing, scanning, faxing, photocopying.

10. The method of claim 8, wherein the paper-interactive operation is one or more of the following operations: printing, scanning, faxing, photocopying.

11. The method of claim 8, wherein the input means includes one or more of the following: a touch screen, a keypad, a keyboard, a magnetic stripe card reader.

12. The method of claim 8, wherein the payment-related information includes at least an identification number identifying a payment means of the user.

13. The method of claim 12 wherein the payment means is a credit or debit card.

14. The method of claim 8, wherein the authentication response includes an indication of a balance in the user's account, and wherein the paper-interactive device is enabled to perform the paper-interactive operation if the balance is sufficient in accordance with a cost of the paper-interactive operation.

15. A non-transitory computer readable storage medium having computer readable program code embodied therewith, the computer readable program code, executable by at least one processor of a paper-interacting device to perform a method, wherein the paper-interacting device is connected to a computerized network via a network connection, the paper-interacting device comprising an input means, and wherein the method comprising:
obtaining, by the processor, payment-related information originating from a user operating the input means;
sending, by the processor, an authentication request, comprising the payment-related information, to a remote payment authentication server, wherein the authentication request is sent via the network connection;
receiving, by the processor, via the network connection, an authentication response originating from the remote payment authentication server; and
enabling, by the processor, the paper-interactive device to perform a paper-interactive operation upon the authentication response being indicative of a successful authentication of the authentication request.

16-40. (canceled)
